(19) United States
(12) Patent Application Publication
(10) Pub. No.: US 2005/0154198 A1
(43) Pub. Date: Jul. 14, 2005

(54) Cross-linked polymers based on cyclodextrins for removing polluting agents

(76) Inventors: Francesco Trotta, Collegno (IT); Wander Tumiatti, Collegno (IT)

Correspondence Address: MATHEWS, COLLINS, SHEPHERD & MCKAY, P.A., 100 THANET CIRCLE, SUITE 306, PRINCETON, NJ, 08540-3674, US

(21) Appl. No.: 10/510,792

(22) PCT Filed: Apr. 10, 2002
(86) PCT No.: PCT/EP02/03989

(51) Int. Cl. C08B 37/16; C02F 1/68

(52) U.S. Cl. 536/103; 210/749

(57) ABSTRACT

Cyclodextrins cross-linked by reaction with organic carbonates and the use thereof as agents capable or removing pollutants from fluids of various origin, in particular from contaminated waters.

The present invention relates to cyclodextrins cross-linked by reaction with organic carbonates and the use thereof as agents capable of removing pollutants from fluids of various origin, in particular from contaminated waters.

The problem of water contamination by a variety of both inorganic and organic pollutants is topical.

More particularly, ground waters and watercourses can often contain organic pollutants which have be thoroughly removed.

According to the prior art, many different alternatives may be contemplated for decontaminating waters: extraction with solvents, reverse osmosis, absorption on zeolites, absorption on activated carbon.

The use of solvents is not an environmentally acceptable process, mainly due to retention of said solvents by the treated waters.

Zeolites are indeed much more suitable for absorbing water than organic molecules. The use of membranes in reverse osmosis processes is a very effective purification technique, but high operative pressures (20-100 bars) are required to overcome the hydrodynamic resistance and generally the available membranes are not 100% selective.

Finally, activated carbon with very high surface area allows to absorb a great number of organic compounds, but it fails to remove those contaminants which, albeit present in waters at extremely low concentrations, of the order of ppb, are still very dangerous for health, or molecules undesired for very specific applications. Such types of widespread molecules are polychlorobiphenyls (PCB) and generally phthalic acid esters.

Furthermore, activated carbon tends to be deactivated in the presence of humidity and has to undergo controlled pyrolysis to be regenerated, which involves at least 10-15% by weight loss of material, thus making any quantitative recovery substantially impossible. Moreover, partial combustion might release highly toxic substances in the atmosphere, and has therefore to be carried out in suitable plants.

Cyclodextrins (CDs) are cyclic, non-reducing oligosaccharides characterized by a typical toroidal cone shape. The atom arrangement in the space is such that the inside cavity is lipophilic, while the outside of the torus is highly hydrophilic. As a consequence, CDs are able to form stable inclusion complexes with organic molecules of suitable polarity and size even in aqueous solution. In the last two decades, CDs have therefore found applications in a variety of fields in chemistry (pharmaceuticals, analytics, catalysts, cosmetics and the like).

However, their inclusion constants are usually rather low and rarely exceed the value of 10³. No significant improvements are attained by transforming CDs into either soluble or insoluble polymers. Unmodified cyclodextrins, therefore, are not useful for removing pollutants from aqueous solutions.

WO 98/22197 discloses cyclodextrins cross-linked with suitable diisocyanates, capable of binding organic compounds even with inclusion constants of 10⁸-10⁹. Among the many organic compounds described, polychlorobiphenyls, phthalic acid esters and halogens are not cited. Furthermore, the production of these cross-linked cyclodextrins involves the use of highly toxic diisocyanates.

It has now been found that cyclodextrins cross-linked through carbonate bonds are able to strongly bind organic molecules and to remove them from aqueous solutions even at very low concentrations.

Therefore, the present invention relates to cross-linked cyclodextrins obtainable by reacting a cyclodextrin with a carbonyl compound of formula X—CO—X wherein X is chlorine, imidazolyl or a —OR group in which R is C₁-C₄ alkyl.

The reaction can be represented by the following scheme:
H—O-β-CD-OH+X—CO—X→-(β-CD-OCOO-β-CD-OCOO)ₙ—
wherein X has the meanings defined above and n is an integer which can range within wide limits, depending on the conditions used in the cross-linking reaction.

The reaction is carried out in carbonyl compound excess, preferably in a X—CO—X/CD molar ratio of 4 to 16, in a suitable solvent, in particular in a polar aprotic solvent such as dimethylformamide, dimethylsulfoxide and the like, optionally in the presence of bases such as tertiary amines. The reaction can be carried out at temperatures ranging from 10° C. to the reflux temperature of the solvent, for times ranging from 1 to 48 hours.

Both natural (α, β, γ) cyclodextrins and derivatives thereof, such as hydroxypropyl-β-cyclodextrins, can be used.

Preferred carbonyl compounds are dimethyl carbonate and carbonyl-diimidazole. Dimethyl carbonate can optionally be used at the same time as solvent and reagent.

The cross-linked cyclodextrins of the invention are in the form of micro- or nano-porous material capable of absorbing with high affinity contaminants of various type from liquid, gaseous or solid matrices, in particular from liquid matrices such as drinking waters, industrial wastes, ground waters, water for special industrial applications (with high purity) and the like. The cross-linked cyclodextrins of the invention proved to be capable of absorbing even very low amounts (such as a few ppb) of compounds such as PCB, dioxins, halogenated hydrocarbons (PCT, PCBT, PCDD, PCDF), aromatic optionally halogenated hydrocarbons, phthalates or other compounds which may be generally defined POPs (Persistent Organic Pollutants). The simple addition of cross-linked cyclodextrins in amounts of about 10-100 mg/ml to the matrix to treat and the subsequent filtration of the solid residue drastically decrease the content of the pollutants present in the matrix itself. Decontamination may be assisted by irradiation with ultrasounds, UV radiation and/or microwaves. Pollutants can be optionally previously extracted from the matrix itself. The pollutants-saturated cyclodextrins can then be recovered by extraction with a suitable solvent.

The invention is illustrated in greater detail in the following examples.

### EXAMPLE 1

4.54 g of anhydrous β-cyclodextrin in 100 ml of anhydrous DMF is added with 5.19 g of carbonyldiimidazole. The reaction proceeds at 70° C. for 24 hours under magnetic stirring. After completion of the reaction, the solution is left to cool at room temperature, then the product is added of a large excess of bidistilled water, recovered by filtration under vacuum, washed with water and subsequently purified by prolonged Soxhlet extraction with ethanol. The resulting product is dried under vacuum and ground in mechanical mill to obtain a homogeneous powder.

### EXAMPLE 2

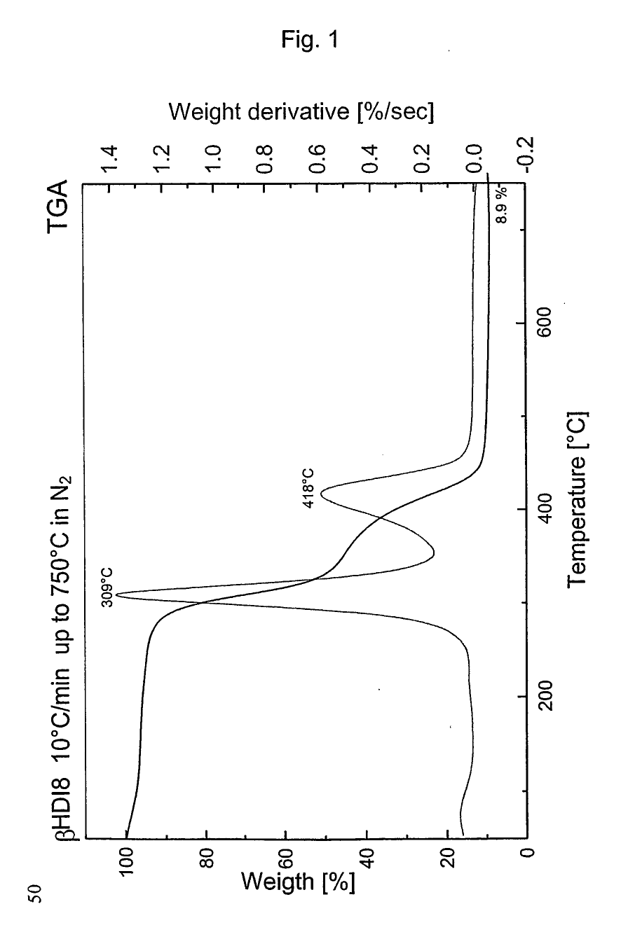

1.0 g of anhydrous α-cyclodextrin in 10 ml of anhydrous DMF is added with 1.34 g of carbonyldiimidazole. The reaction proceeds at 70° C. for 24 hours under magnetic stirring. After completion of the reaction, the solution is left to cool at room temperature, the product is added of a large excess of bidistilled water, then recovered by filtration under vacuum, washed with water and subsequently purified by prolonged Soxhlet extraction with ethanol. The resulting product is dried under vacuum and ground in a mechanical mill to obtain a homogeneous powder. Thermogravimetric analysis of the resulting polymer is reported in FIG. 1.

### EXAMPLE 3

1.0 g of anhydrous γ-cyclodextrin in 10 ml of anhydrous DMF is added with 1.0 g of carbonyldiimidazole. The reaction proceeds at 70° C. for 24 hours under magnetic stirring. After completion of the reaction, the solution is left to cool at room temperature, the product is added of a large excess of bidistilled water, then recovered by filtration under vacuum, washed with water and subsequently purified by prolonged Soxhlet extraction with ethanol. The resulting product is dried under vacuum and ground in a mechanical mill to obtain a homogeneous powder.

### EXAMPLE 4

3.0 g of anhydrous HP-β-cyclodextrin in 30 ml of anhydrous DMF is added with 3.0 g of carbonyldiimidazole. The reaction proceeds at 70° C. for 24 hours under magnetic stirring. After completion of the reaction, the solution is left to cool at room temperature, the product is added of a large excess of bidistilled water, recovered by filtration under vacuum, washed with water and subsequently purified by prolonged Soxhlet extraction with ethanol. The resulting product is dried under vacuum and ground in a mechanical mill to obtain a homogeneous powder.

### EXAMPLE 5

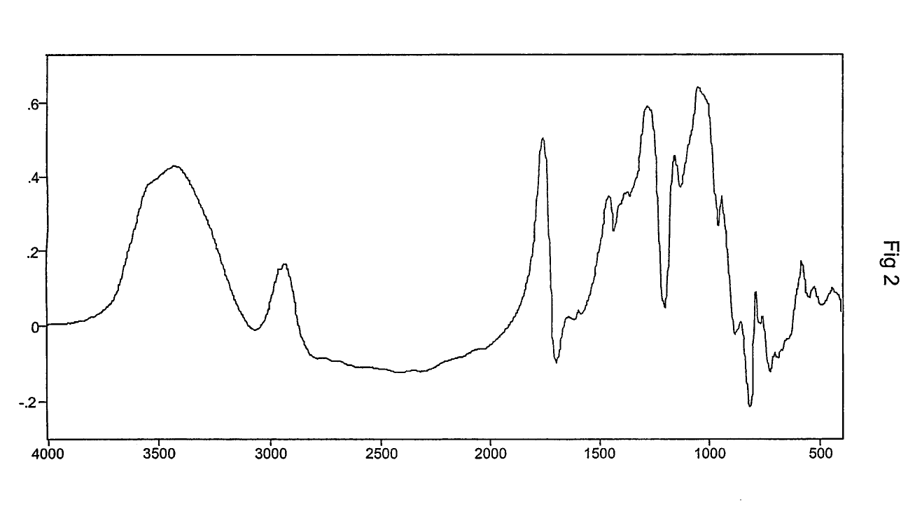

2.0 g of anhydrous β-cyclodextrin are dissolved in 30 ml of anhydrous DMF. The solution is added 1 ml of triethylamine and 14.8 ml of dimethylcarbonate, then refluxed for 3 hours. After completion of the reaction, the solution shows increase in viscosity and the solvent is evaporated off under vacuum. The resulting polymer is purified by prolonged Soxhlet extraction. FT-IR spectrum of the resulting polymer is reported in FIG. 2.

### EXAMPLE 6

3 g of anhydrous dextrin 10 are added to 30 ml of anhydrous DMF. 2.32 g of CDI are added thereto, reacting for 1 hour at 100° C. After completion of the reaction, the resulting solid is recovered, washed with hot water, then with ethanol, dried and ground in a mechanical mill to obtain a homogeneous powder.

The resulting polymers were tested for removal of organic molecules from aqueous solutions.

### EXAMPLE 7

5 ml of water containing 350 ppm of chlorobenzene was added with 100 mg of polymer of Example 2. Once reached equilibrium, the solid was filtered off and the solution analyzed at UV-Vis. The concentration of residual chlorobenzene was 52 ppm (retention ability about 15 mg/g of resin).

### EXAMPLE 8

5 ml of water containing 325 ppm of chlorobenzene was added with 100 mg of polymer of example 1. Once reached equilibrium, the solid was filtered off and the solution analyzed at UV-Vis. The concentration of residual chlorobenzene was 27 ppm.

### EXAMPLE 9

5 ml of water containing 350 ppm of chlorobenzene was added with 100 mg of polymer of example 3. Once reached equilibrium, the solid was o filtered off and the solution analyzed at UV-Vis. The concentration of residual chlorobenzene was 90 ppm.

### EXAMPLE 10

5 ml of water containing 350 ppm of chlorobenzene was added with 100 mg of polymer of example 4. Once reached equilibrium, the solid was filtered off and the solution analyzed at UV-Vis. The concentration of residual chlorobenzene was 40 ppm.

### EXAMPLE 11

5 ml of water containing 40 ppm of chlorobenzene was added with 200 mg of polymer of example 1. Once reached equilibrium, the solid was filtered off and the solution analyzed by GC-MS. No traces of residual chlorobenzene were detected.

### EXAMPLE 12

5 ml of an aqueous solution saturated with a mixture of chlorobiphenyl congeners named Askarel was added with 100 mg of polymer of example 1. Once reached equilibrium, the solid was filtered off and the solution analyzed by GC-MS. No traces of residual PCB congeners were detected.

### EXAMPLE 13

5 ml of an aqueous solution saturated with dibutyl phthalate (13 ppm) was added with 100 mg of polymer of example 2. Once reached equilibrium, the solid was filtered off and the solution analyzed by GC-MS. The phthalates residual concentration was 2.6 ppm.

### EXAMPLE 14

5 ml of an aqueous solution saturated with a mixture of dibutyl phthalate congeners (13 ppm) was added with 500 mg of polymer of example 2. Once reached equilibrium, the solid was filtered off and the solution analyzed by GC-MS. No traces of phthalates were detected in the aqueous solution.

### EXAMPLE 15

A chlorobenzene aqueous solution (5 ml) containing 330 ppm of chlorobenzene was added with 100 mg of polymer of example 1. Once reached equilibrium, the solid was recovered by filtration and immersed in ml of absolute ethanol. The alcoholic solution was removed from the solid and analyzed at UV-Vis. Analysis showed the quantitative recovery of chlorobenzene so that the polymer could be recycled without substantial loss of activity and capacity.

### EXAMPLE 16

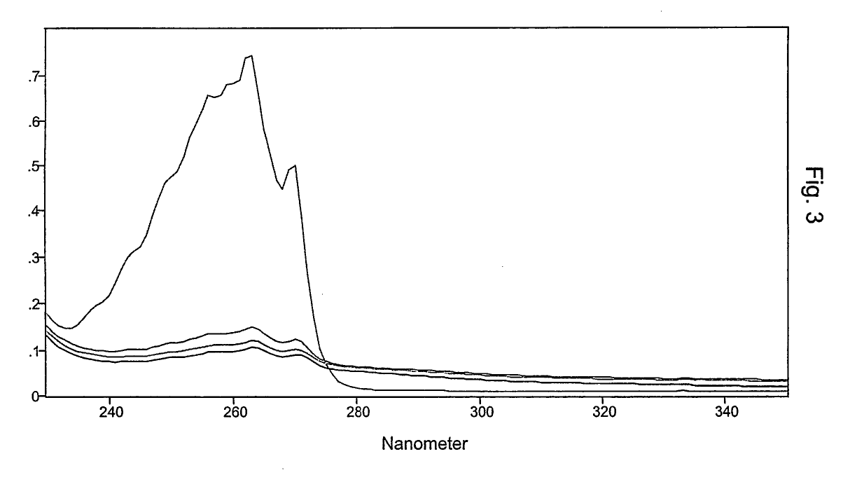

A chlorobenzene aqueous solution (5 ml) containing 400 ppm of chlorobenzene was added with 100 mg of polymer of example 5. Once reached equilibrium, the solid was filtered off and the solution analyzed at UV-Vis. FIG. 3 reports the chlorobenzene residual concentrations after 30 minutes, 1 and 24 hours, from top to bottom, respectively.

1. Cross-linked cyclodextrins obtainable by reacting a cyclodextrin with a carbonyl compound of formula X—CO—X wherein X is chlorine, imidazolyl or n —OR group in which R is C₁-C₄ alkyl.

2. Cross-linked cyclodextrins as claimed in claim 1, wherein cyclodextrins are selected from natural cyclodextrins (a, 13, y) and the derivatives thereof.

3. Cyclodextrins as claimed in claim 2, wherein cyclodextrins derivatives are hydroxypropyl-cyclodextrins.

4. Cyclodextrins as claimed in claim 1, cross-linked by reaction with dimethylcarbonate or carbonyl-diimidazole.

5. Cross-linked cyclodextrins as claimed in claim 1, obtainable by reacting a cyclodextrin with a carbonyl compound excess.

6. Cross-linked cyclodextrins as claimed in claim 5, wherein the carbonyl compound/cyclodextrin ratio ranges from 4 to 16.

7. A process for the decontamination of liquid, gaseous or solid matrices, which comprises adding said matrices with an effective amount of the cross-linked cyclodextrins of claim 1, followed by filtration/separation of to the solid residue.

8. A process as claimed in claim 7, wherein the matrix is water and the pollutants are polychlorinated biphenyls (PCBs), polychlorinated terphenyls (PCTs), PCBT, polychlorinated dibenzo-p-dioxins (PCDDs), polychlorinated dibenzofurans (PCDFs), Persistent Organic Pollutants (POPs).

9. A process as claimed in claim 8, wherein the cross-linked cyclodextrins are used directly on the matrix and/or indirectly through extraction of the pollutant from the matrix itself.

10. A process as claimed in claim 7, further comprising the treatment of the matrices with ultrasounds, microwaves and/or UV radiation.

11. A process for the recovery of the pollutant-saturated cross-linked cyclodextrins of claim 1 by extraction with a suitable solvent.
